(19) United States
(12) Patent Application Publication
(10) Pub. No.: US 2024/0155328 A1
(43) Pub. Date: May 9, 2024

(54) A FRAMEWORK FOR SHARED RF COMPONENTS IN ENDC AND MSIM

(71) Applicant: QUALCOMM Incorporated, San Diego, CA (US)

(72) Inventors: Yu FU, San Diego, CA (US); Junyi WANG, San Diego, CA (US); Yong SU, Shenzhen (CN); Udayan BHAWNANI, San Diego, CA (US); Scott HOOVER, Del Mar, CA (US); Sandeep RAO, San Diego, CA (US); Zhong FAN, San Diego, CA (US); Rimal Hasmukhbhai PATEL, San Diego, CA (US); Brian GEORGE, San Diego, CA (US); Varun CHATARAJU, San Diego, CA (US); Thawatt GOPAL, San Diego, CA (US); Qingxin CHEN, San Diego, CA (US); Reza SHAHIDI, La Jolla, CA (US)

(21) Appl. No.: 18/548,559

(22) PCT Filed: Apr. 30, 2021
(86) PCT No.: PCT/CN2021/091460

§ 371 Date: Aug. 31, 2023

(51) Int. Cl. H04W 8/20; H04W 76/15

(52) U.S. Cl. CPC H04W 8/20; H04W 76/15

(57) ABSTRACT

Certain aspects of the present disclosure provide a technique for wireless communications by a user equipment (UE). The UE monitors a concurrent operation on multiple operating bands within a same subscriber identity module (SIM) or between multiple SIMs that involves sharing at least one radio frequency (RF) component. The UE enables or disables the at least one RF component based on the monitoring.

### BACKGROUND

### Field of the Disclosure

Aspects of the present disclosure relate to wireless communications, and more particularly, to techniques for managing shared radio frequency (RF) components of a user equipment (UE) operating in an evolved universal terrestrial radio access (E-UTRA) new radio (NR)—dual connectivity (ENDC) mode and/or a multiple subscriber identity module (MSIM) mode.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd generation partnership project (3GPP) long term evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more BSs may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., which may be referred to as a BS, 5G NB, next generation NodeB (gNB or gNodeB), TRP, etc.). A BS or DU may communicate with a set of UEs on downlink (DL) channels (e.g., for transmissions from a BS or to a UE) and uplink (UL) channels (e.g., for transmissions from a UE to a BS or DU).

These multiple access technologies have been adopted in various telecommunication standards to provide a common protocol that enables different wireless devices to communicate on a municipal, national, regional, and even global level. New Radio (NR) (e.g., 5^{th} generation (5G)) is an example of an emerging telecommunication standard. NR is a set of enhancements to the LTE mobile standard promulgated by 3GPP. It is designed to better support mobile broadband Internet access by improving spectral efficiency, lowering costs, improving services, making use of new spectrum, and better integrating with other open standards using OFDMA with a cyclic prefix (CP) on a DL and on an UL. To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved and desirable techniques for managing shared radio frequency (RF) components of a user equipment (UE) operating in an evolved universal terrestrial radio access (E-UTRA) new radio (NR)—dual connectivity (ENDC) mode and/or a multiple subscriber identity module (MSIM) mode.

Certain aspects provide a method of wireless communications by a UE. The method generally includes monitoring a concurrent operation on multiple operating bands within a same subscriber identity module (SIM) or between multiple SIMs that involves sharing at least one RF component; and enabling or disabling the at least one RF component based on the monitoring.

Certain aspects provide an apparatus for wireless communications by a UE. The apparatus generally includes at least one processor and a memory configured to: monitor a concurrent operation on multiple operating bands within a same SIM or between multiple SIMs that involves sharing at least one RF component; and enable or disable the at least one RF component based on the monitoring.

Certain aspects provide an apparatus for wireless communications. The apparatus generally includes means for monitoring a concurrent operation on multiple operating bands within a same SIM or between multiple SIMs that involves sharing at least one RF component; and means for enabling or disabling the at least one RF component based on the monitoring.

Certain aspects of the subject matter described in this disclosure can be implemented in a computer readable medium storing computer executable code thereon for wireless communications. The computer readable medium comprises code for monitoring a concurrent operation on multiple operating bands within a same SIM or between multiple SIMs that involves sharing at least one RF component; and code for enabling or disabling the at least one RF component based on the monitoring.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example base station (BS) and a user equipment (UE), in accordance with certain aspects of the present disclosure.

FIG. 3 is an example frame format for certain wireless communication systems (e.g., a new radio (NR)), in accordance with certain aspects of the present disclosure.

FIG. 4 illustrates connected mode discontinuous reception (CDRX) operations, in accordance with certain aspects of the present disclosure.

FIG. 5 illustrates an example evolved universal terrestrial radio access (E-UTRA) new radio (NR)—dual connectivity (ENDC) mode scenario, in accordance with certain aspects of the present disclosure.

FIG. 6 illustrates an example multiple subscriber identity module (MSIM) mode scenario, in accordance with certain aspects of the present disclosure.

FIG. 7 illustrates example of shared radio frequency (RF) components for an MSIM deployment for a UE, in accordance with certain aspects of the present disclosure.

FIG. 8 is a flow diagram illustrating example operations for wireless communication by a UE, in accordance with certain aspects of the present disclosure.

FIG. 9 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatuses, methods, processing systems, and computer readable mediums for managing shared radio frequency (RF) components of a user equipment (UE) operating in an evolved universal terrestrial radio access (E-UTRA) new radio (NR)—dual connectivity (ENDC) mode and/or a multiple subscriber identity module (MSIM) mode.

In one example, the shared RF components of the UE may be disabled when each of multiple radio access technologies (RATs) shared within a same subscriber identity module (SIM) or multiple SIMs may vote to disable the shared RF components. In another example, the shared RF components of the UE may be enabled when at least one of the multiple RATs shared within the same SIM or the multiple SIMs may vote to enable the shared RF components.

The following description provides examples of managing of shared RF components of a UE in wireless communication systems. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3rd generation (3G), 4G, and/or new radio (e.g., 5G new radio (NR)) wireless technologies, aspects of the present disclosure can be applied in other generation-based communication systems.

NR access may support various wireless communication services, such as enhanced mobile broadband (eMBB) targeting wide bandwidth, millimeter wave mmW, massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

### Example Wireless Communications System

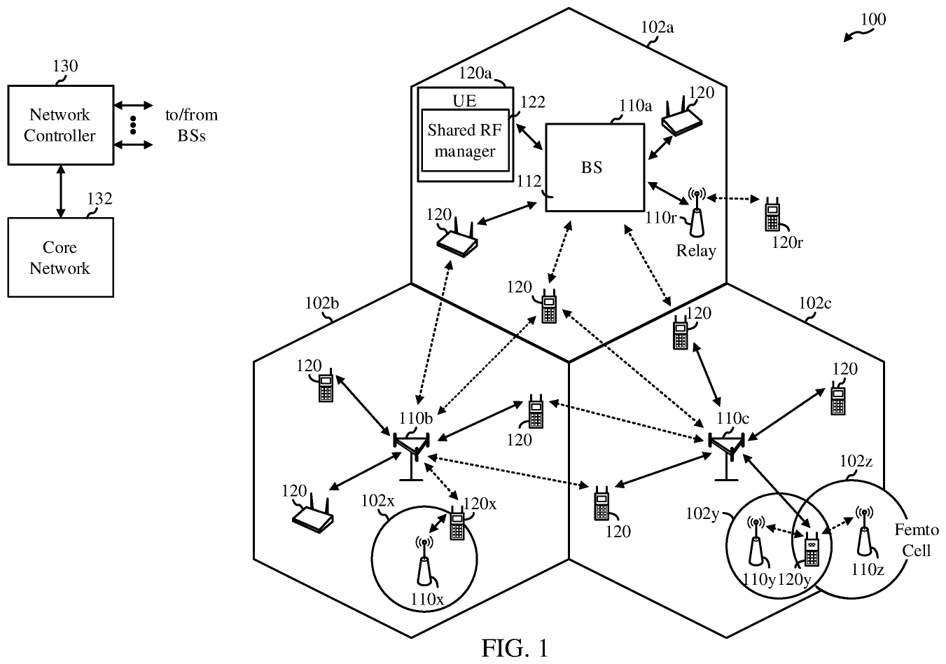

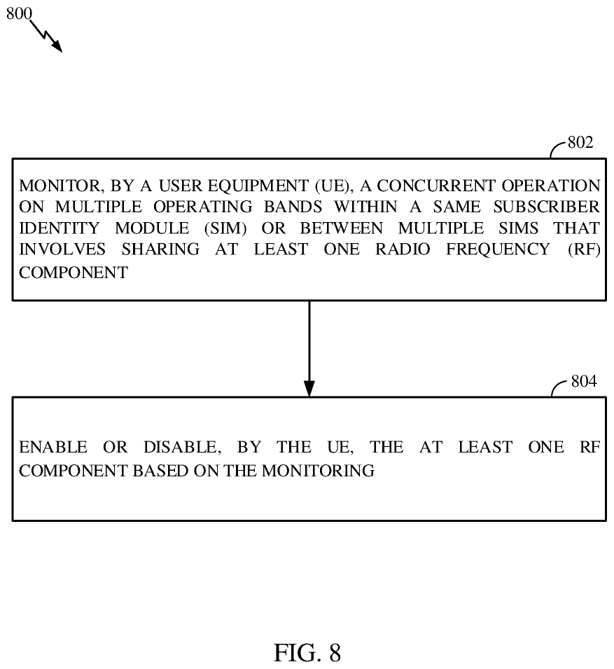

FIG. 1 illustrates an example wireless communication network 100 in which aspects of the present disclosure may be performed. For example, according to certain aspects, the wireless communication network 100 may include base stations (BSs) 110 and/or user equipments (UEs) 120. As shown in FIG. 1, a UE 120a includes a shared radio frequency (RF) manager 122 configured to perform operations 800 of FIG. 8.

The wireless communication network 100 may be a new radio (NR) system (e.g., a 5th generation (5G) NR network). As shown in FIG. 1, the wireless communication network 100 may be in communication with a core network. The core network may in communication with BSs 110a-z (each also individually referred to herein as a BS 110 or collectively as BSs 110) and/or UEs 120a-y (each also individually referred to herein as a UE 120 or collectively as UEs 120) in the wireless communication network 100 via one or more interfaces.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120 in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

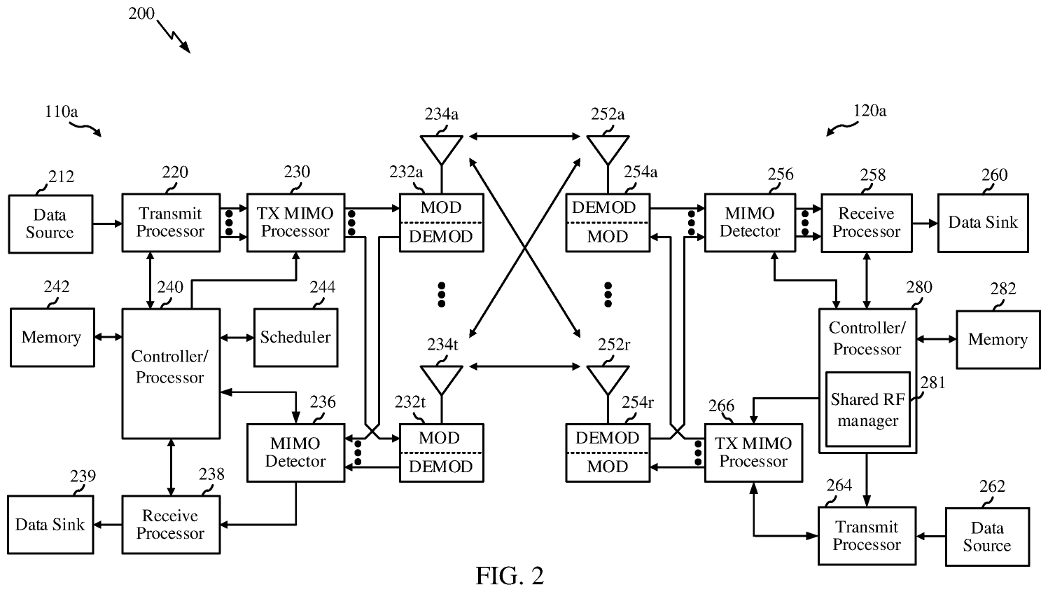

FIG. 2 illustrates example components of a BS 110a and a UE 120a (e.g., in the wireless communication network 100 of FIG. 1).

At the BS 110a, a transmit processor 220 may receive data from a data source 212 and control information from a controller/processor 240. The control information may be for a physical broadcast channel (PBCH), a physical control format indicator channel (PCFICH), a physical hybrid ARQ (automatic repeat request) indicator channel (PHICH), a physical downlink control channel (PDCCH), a group common PDCCH (GC PDCCH), etc. The data may be for a physical downlink shared channel (PDSCH), etc. A medium access control—control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The transmit processor 220 may process (e.g., encode and symbol map) the data and control information to obtain data symbols and control symbols, respectively. The transmit processor 220 may also generate reference symbols, such as for a primary synchronization signal (PSS), a secondary synchronization signal (SSS), and a channel state information reference signal (CSI-RS). A transmit multiple-input multiple-output (MIMO) processor 230 may perform spatial processing (e.g., precoding) on the data symbols, the control symbols, and/or the reference symbols, if applicable, and may provide output symbol streams to modulators (MODs) in transceivers 232a-232t. Each MOD in transceivers 232a-232t may process a respective output symbol stream (e.g., for orthogonal frequency division multiplexing (OFDM), etc.) to obtain an output sample stream. Each MOD in transceivers 232a-232t may further process (e.g., convert to analog, amplify, filter, and upconvert) the output sample stream to obtain a downlink (DL) signal. The DL signals from the MODs in transceivers 232a-232t may be transmitted via antennas 234a-234t, respectively.

At the UE 120a, antennas 252a-252r may receive DL signals from the BS 110a and may provide received signals to demodulators (DEMODs) in transceivers 254a-254r, respectively. Each DEMOD in the transceiver 254 may condition (e.g., filter, amplify, downconvert, and digitize) a respective received signal to obtain input samples. Each DEMOD in the transceiver 254 may further process the input samples (e.g., for OFDM, etc.) to obtain received symbols. A MIMO detector 256 may obtain received symbols from all the DEMODs in the transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On an uplink (UL), at the UE 120a, a transmit processor 264 may receive and process data (e.g., for a PUSCH) from a data source 262 and control information (e.g., for a physical uplink control channel (PUCCH) from the controller/processor 280. The transmit processor 264 may also generate reference symbols for a reference signal (e.g., for a sounding reference signal (SRS)). The symbols from the transmit processor 264 may be precoded by a transmit MIMO processor 266 if applicable, further processed by the MODs in transceivers 254a-254r (e.g., for SC-FDM, etc.), and transmitted to the BS 110a. At the BS 110a, the UL signals from the UE 120a may be received by the antennas 234, processed by the DEMODs in transceivers 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

Memories 242 and 282 may store data and program codes for the BS 110a and the UE 120a, respectively. A scheduler 244 may schedule the UE 120a for data transmission on a DL and/or an UL.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 280 of the UE 120a has a shared RF manager 281 that may be configured to perform the operations illustrated in FIG. 8, as well as other operations disclosed herein. Although shown at the controller/processor, other components of the UE 120a and the BS 110a may be used to perform the operations described herein.

NR may utilize OFDM with a cyclic prefix (CP) on the UL and the DL. The NR may support half-duplex operation using time division duplexing (TDD). The OFDM and single-carrier frequency division multiplexing (SC-FDM) partition system bandwidth into multiple orthogonal subcarriers, which are also commonly referred to as tones, bins, etc. Each subcarrier may be modulated with data. Modulation symbols may be sent in a frequency domain with the OFDM and in a time domain with the SC-FDM. The spacing between adjacent subcarriers may be fixed, and a total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. The NR may support a base subcarrier spacing (SCS) of 15 KHz and other SCS may be defined with respect to the base SCS (e.g., 30 kHz, 60 kHz, 120 kHz, 240 kHz, etc.).

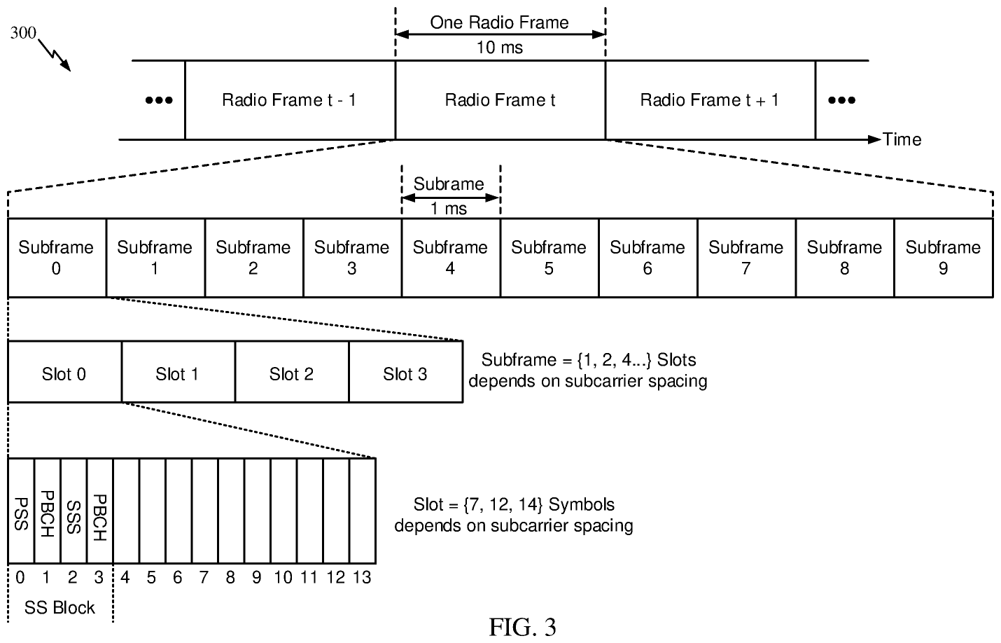

FIG. 3 is a diagram showing an example of a frame format 300 for NR. A transmission timeline for each of DL and UL may be partitioned into units of radio frames. Each radio frame may have a predetermined duration (e.g., 10 ms), and may be partitioned into 10 subframes, each of 1 ms, with indices of 0 through 9. Each subframe may include a variable number of slots (e.g., 1, 2, 4, 8, 16, . . . slots) depending on a SCS. Each slot may include a variable number of symbol periods (e.g., 7, 12, or 14 symbols) depending on the SCS. Symbol periods in each slot may be assigned indices. A sub-slot structure may refer to a transmit time interval having a duration less than a slot (e.g., 2, 3, or 4 symbols). Each symbol in a slot may be configured for a link direction (e.g., a DL, an UL, or a flexible) for data transmission, and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and the SSS may be used by UEs for cell search and acquisition. The PSS may provide half-frame timing, a synchronization signal (SS) may provide a CP length and frame timing. The PSS and the SSS may provide cell identity. The PBCH carries some basic system information, such as DL system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a PDSCH in certain subframes. The SSB can be transmitted up to sixty-four times, for example, with up to sixty-four different beam directions for mmWave. The multiple transmissions of the SSB are referred to as a SS burst set. The SSBs in an SS burst set may be transmitted in the same frequency region, while the SSBs in different SS bursts sets can be transmitted at different frequency regions.

### Example CDRX Operation

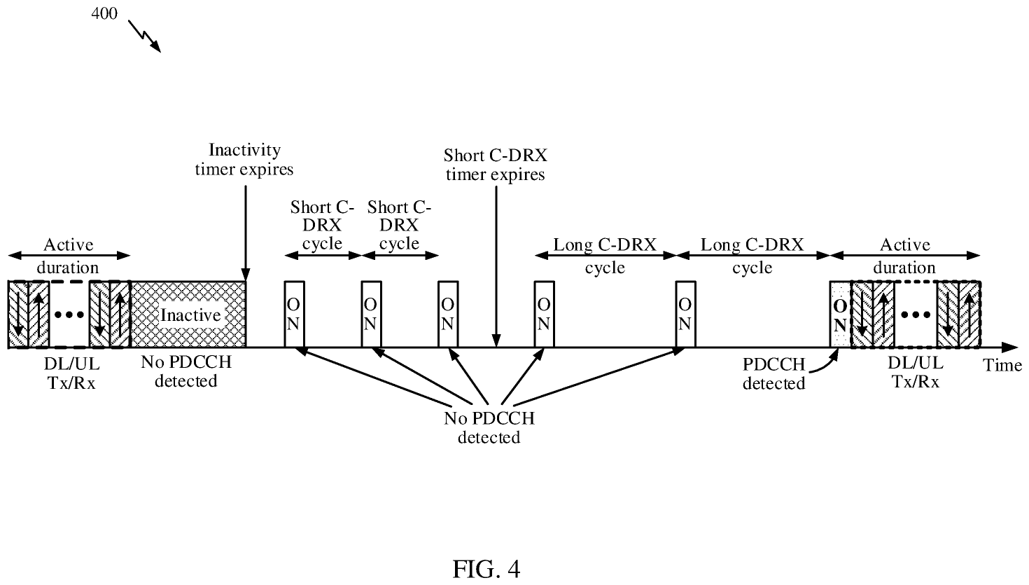

A user equipment (UE) switches to a connected discontinuous reception (CDRX) operation, during periods of traffic inactivity, as illustrated in an example timing diagram 400 of FIG. 4, for power saving.

In the CDRX, when there is no data transmission in either direction (e.g., an uplink (UL)/a downlink (DL) direction) for the UE in a radio resource control (RRC) connected mode, the UE goes into a discontinuous reception (DRX) mode. In the CDRX, the UE monitors a physical downlink control channel (PDCCH) discontinuously. In other words, the UE alternates between sleep (i.e., DRX OFF) cycles and wake (i.e., DRX ON) cycles. The CDRX results in the power savings because, without the DRX cycles, the UE would needlessly monitor for the PDCCH transmissions in every subframe to check if there is DL data available.

The UE is configured for the CDRX according to various configuration parameters such as an inactivity timer, a short DRX timer, a short DRX cycle, and a long DRX cycle.

As further illustrated in FIG. 4, based on configured cycles, the UE wakes up occasionally for ON durations and monitors for the PDCCH transmissions. Except for the ON durations, the UE remains in a low power (sleep) state referred to as an OFF duration, for the rest of a CDRX cycle. During the OFF duration, the UE is not expected to transmit and receive any signal.

The UE wakes up at a termination of a CDRX mode. For example, if the UE detects a PDCCH scheduling data during the ON duration, the UE remains on to transmit and receive data. Otherwise, the UE goes back to sleep at the end of the ON duration.

### Example ENDC Operation

In certain wireless communication systems (e.g., 5^{th} generation (5G) new radio (NR)), a user equipment (UE) is configured to communicate with multiple groups of cells, such as a master cell group (MCG) and a secondary cell group (SCG), which is referred to as dual connectivity. The dual connectivity enables a network to provide more bandwidth to the UE depending on a resource budget allocated to each cell group. The MCG may be limited on its resource budget due to an influx of connected UEs. The network may configure one of the UEs for the dual connectivity with the SCG to offload some of bandwidth consumed by the UE. In other cases, the dual connectivity enables the network to provide low latency radio bearers to the UE via one of the cell groups, such as the SCG, and allow other traffic to flow through the MCG.

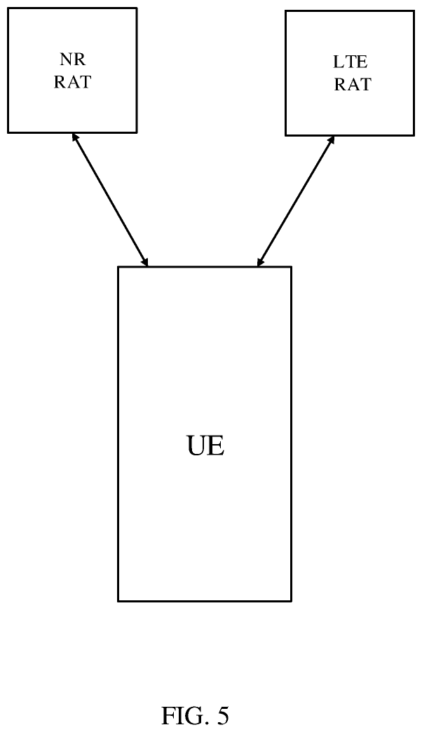

The UE may be configured for various dual connectivity configurations. For example, as illustrated in FIG. 5, the UE (with 4 to 5 antennas) is configured for evolved UMTS terrestrial radio access network (E-UTRAN) new radio—dual connectivity (ENDC) involving multiple radio access technology (RAT) combinations.

In ENDC non-standalone (NSA) or standalone (SA) connected mode, as illustrated in FIG. 5, multiple RAT combinations (such as a first RAT (e.g., a new radio (NR) RAT) and a second RAT (e.g., a long term evolution (LTE) RAT)) have overlapping bands. In a current implementation for such RAT combinations, radio frequency (RF) resources of the UE are shared between both the LTE and NR RATs to handle these RAT combinations that have these overlapping bands. The RF resources may include RF components (or RF front end (RFFE) components) such as a low noise amplifier (LNA), an antenna switching module (ASM), a cross switch, etc. For example, mid band (MB) and high band (HB) may need to share the ASM and/or the cross switch between the NR RAT and the LTE RAT in the ENDC.

In some cases, the ASM and/or the cross switch may be shared to handle the LTE and NR RATs combinations that may have a first set of overlapping bands. The first set of overlapping bands may include B1/B3/B34/B39/B40+N41 frequency bands and B41+N1/N3 frequency bands.

In some cases, the LNA may be shared to handle the LTE and NR RATs combinations that may have a second set of overlapping bands. In one example, the LTE RAT (e.g., a primary component carrier (PCC)) may share with the NR RAT the second set of overlapping bands such as B41+n41 frequency bands, B20+n28 frequency bands, etc. In another example, the LTE RAT (e.g., a secondary component carrier (SCC)) may share with the NR RAT the second set of overlapping bands such as B66/n66/N71, B2/n2, B5/n5, B42/n77/n78/n79, B48/n77/n78/N79, B71+n71, B7+B38/N38, etc.

In ENDC mode, the LTE RAT and the NR RAT may have independent activities with a full concurrency. Also, as noted above, the LTE RAT and the NR RAT may share the RF devices for the overlapping bands. Furthermore, when the UE is in the ENDC mode, connected discontinuous reception (CDRX) parameters are configured on both the LTE RAT and the NR RAT to achieve power saving at both the UE and network side.

Based on the CDRX parameters and configurations on both the LTE RAT and the NR RAT, a start time for on/off period of a CDRX cycle on the NR RAT may be same or different than a start time for on/off period of a CDRX cycle on the LTE RAT. In some cases (where the LTE RAT and the NR RAT are sharing the RF devices for the overlapping bands), based on the CDRX parameters and configurations, when one RAT (e.g., the LTE RAT) may go to sleep (i.e., the off period of its CDRX cycle), this may shutdown the shared RF devices as well. However, other RAT (e.g., the NR RAT) may be awake (i.e., the on period of its CDRX cycle) at this time and may need to use these shared RF devices. In this case where the NR RAT may need to use the shared RF devices, but the shared RF devices are shut down due to the shutdown of the LTE RAT may lead to an operational inefficiency.

Aspects of the present disclosure provide techniques for appropriately managing enablement and disablement of RF devices when RAT combinations (such as a LTE RAT and a NR RAT) have overlapping bands that require sharing of these RF devices.

### Example MSIM Operation

New radio (NR) concurrent radio access technology (RAT) operation refers to operating multiple simultaneous active connections with at least one connection being on the NR. For example, the two connections may involve long term evolution (LTE) and NR connections, or both NR connections. Multiple subscriber identity module (MSIM) devices are able to connect to multiple networks independently without network awareness. Different UE behaviors may occur based on different implementations like a dual-SIM dual active (DSDA) or a dual-SIM dual standby (DSDS). The DSDS refers to a dual-SIM deployment where the two SIM cards of the UE may be unable to simultaneously generate traffic. The DSDA on the other hand refers to a dual-SIM deployment where both SIM cards of the UE may be active at the same time. As used herein, a SIM generally refers to both virtual and hardware implementations of a SIM. In other words, each SIM may be implemented using hardware (e.g., a physical SIM card) on the MSIM device, or implemented virtually using a remote database.

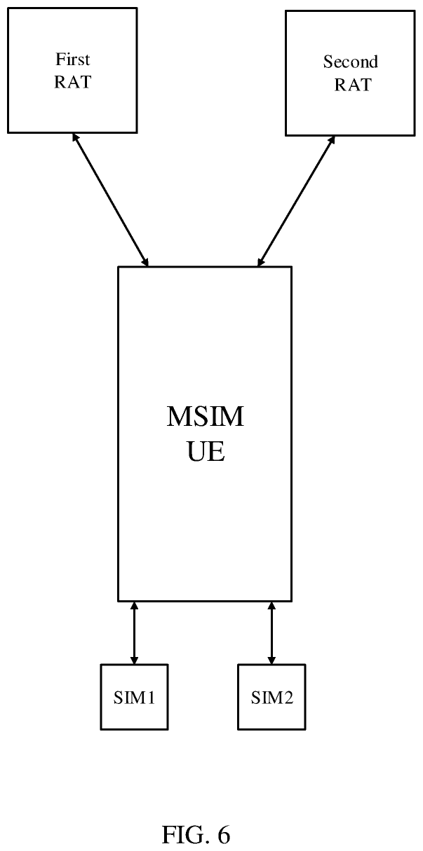

FIG. 6 illustrates an example MSIM deployment, in which a MSIM UE supports two SIMs (SIM1 and SIM2), which may support same or different RATs. At any given time, the two SIMs may concurrently be in an idle state and may support different modes of operation. For example, the MSIM UE with a single receiver may support a single receive dual SIM dual standby (SR-DSDS) mode, where only one RAT is received at a time. In a dual receive (DR)-DSDS mode, the MSIM UE may simultaneously multiple RATs at a time.

MSIM receivers allow different SIMs to support a variety of different combination options. For example, MSIM devices could support the following:
SA-NR+SA-NR: both SIMs could support standalone (SA) NR (SA-NR);
NSA-NR+LTE: one SIM supports non-standalone (NSA) while another SIM supports LTE;
LTE+LTE: both SIMs support LTE;
LTE+W: one SIM supports LTE, the other supports wideband CDMA; or any other combination (X RAT+X RAT both SIMs the same RAT or X RAT+Y RAT the SIMs support different RATs).

In some cases, in a MSIM deployment, each SIM of a UE can belong to a same network carrier. For example, two or more SIMs (also referred to herein as subscribers or SUBs) belonging to a same operator can be in the following modes:
(1) Idle+Idle: 2 or more SUBs in Idle camp to the same cell
(2) Connected+Idle: 1 SUB in Idle and 1 Sub Connected camp to the same cell

In some cases, in a MSIM deployment, a MSIM receiver may support a full concurrency (e.g., NR SA or NSA+LTE). In some cases, a full MSIM receiver capacity may be needed on a NR data distribution service (DDS). In some cases, a full MSIM receiver capacity may be needed for paging on new DDS (nDDS) SIM (e.g., two MSIM receivers may be needed for LTE, wideband code division multiple access (WCDMA), code division multiple access (CDMA) and global system for mobile communications (GSM)). In some cases, a cross SIM (e.g., between multiple SIMs) coordination may be needed to ensure that SIM1 NR may keep sXSW active till SIM2 LTE may sleep (or gets disabled). In some cases, the NR may be nDDS SIM. In some cases, evolved UMTS terrestrial radio access network (E-UTRAN) new radio—dual connectivity (ENDC)+NR may be three RATs that may be completely concurrent of DDS SIM LTE and NR+nDDS SIM NR.

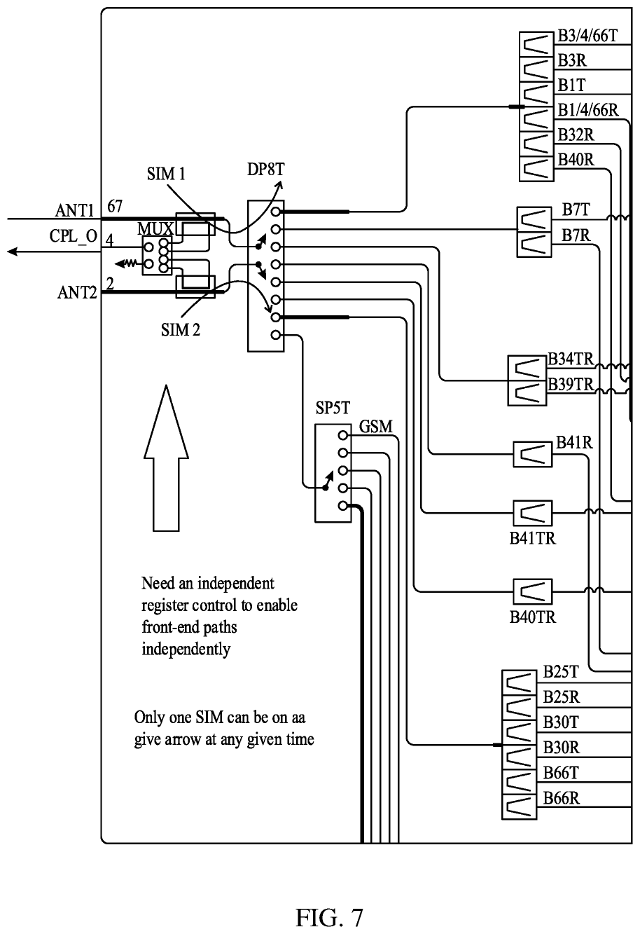

In some cases, as illustrated in FIG. 7, a sharing of an internal path of an antenna switching module (ASM) of a MSIM device (e.g., a same settings index) across multiple SIMs (e.g., SIM 1 and SIM 2) may not be supported. For example, a physical ASM may be shared, however internal paths used across the multiple SIMs have to be separate. Also, these internal paths of the ASM have to be independently controllable via different bits or registers of the MSIM device. However, some MSIM devices may have a hardware limitation that may cause sharing of the internal paths of the ASM across the multiple SIMs.

In some cases, a MSIM concurrency table in radio frame coordination (RFC) functions may allow some selected internal paths of the ASM across the multiple SIMs to be used concurrently. For example, the MSIM concurrency table may resolve MSIM resource allocation concerns (assuming that MSIM device hardware guidelines/requirements have been accomplished), and thus the use of the MSIM concurrency table is able to ensure that the internal paths used across the multiple SIMs are separate. However, the use of the MSIM concurrency table is not able to bypass the need for independent control of the internal paths of the ASM. As noted above, since the internal paths of the ASM used across the multiple SIMs have to be separate as well as independently controllable via the different bits or registers, without the independent control of the internal paths of the ASM, there will be functional failures during MSIM concurrency.

In some cases, a radio frequency (RF) front end path programming may be needed to support enabling and programming of two RF front end paths in a MSIM device independently for MSIM concurrency. In some cases, RF front end components/modules may be needed to support an independent control (e.g., an independent register control) to enable and program the two front end paths of the MSIM device independently for the MSIM concurrency. This will ensure that when SIM 1 (as illustrated in FIG. 7) is programmed, any programming of SIM 2 does not impact SIM 1.

### Example Framework for Shared RFFE Components in ENDC and MSIM

Aspects of the present disclosure provide apparatuses, methods, processing systems, and computer readable mediums for managing enabling and disabling of shared radio frequency (RF) components of a user equipment (UE) operating in an evolved universal terrestrial radio access (E-UTRA) new radio (NR)—dual connectivity (ENDC) mode and/or a multiple subscriber identity module (MSIM) mode. The subject matter described herein provides effective management and configuration of the shared RF components to achieve higher operational efficiency.

FIG. 8 is a flow diagram illustrating example operations 800 for wireless communication, in accordance with certain aspects of the present disclosure. The operations 800 may be performed, for example, by a UE (e.g., such as the UE 120a in the wireless communication network 100). The operations 800 may be implemented as software components that are executed and run on one or more processors (e.g., the controller/processor 280 of FIG. 2). Further, the transmission and reception of signals by the UE in operations 800 may be enabled, for example, by one or more antennas (e.g., the antennas 252 of FIG. 2). In certain aspects, the transmission and/or reception of signals by the UE may be implemented via a bus interface of one or more processors (e.g., the controller/processor 280) obtaining and/or outputting signals.

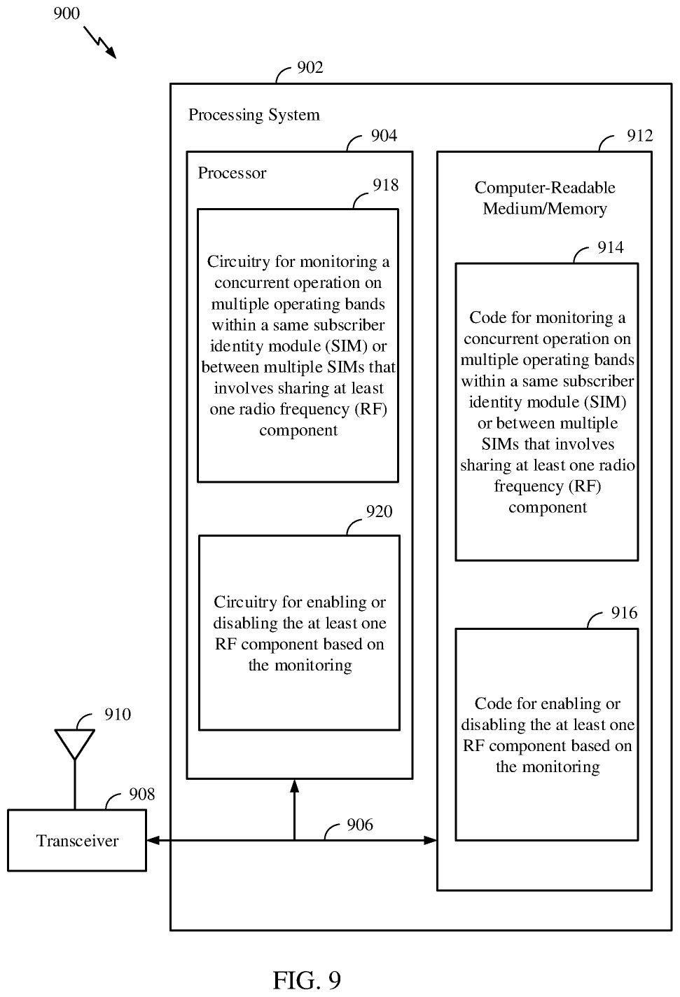

The operations 800 begin, at block 802, by monitoring a concurrent operation on multiple operating bands within a same subscriber identity module (SIM) or between multiple SIMs that involves sharing at least one RF component. In one example, the UE may monitor the concurrent operation on the multiple operating bands within the same SIM or between the multiple SIMs using a software component of the UE 120a shown in FIG. 1 or FIG. 2 and/or of the apparatus shown in FIG. 9. In another example, the UE may monitor the concurrent operation on the multiple operating bands within the same SIM or between the multiple SIMs using a hardware component of the UE 120a shown in FIG. 1 or FIG. 2 and/or of the apparatus shown in FIG. 9.

At 804, the UE enables or disables the at least one RF component based on the monitoring. In one example, the UE may enable or disable the at least one RF component using the software component of the UE 120a shown in FIG. 1 or FIG. 2 and/or of the apparatus shown in FIG. 9. In another example, the UE may enable or disable the at least one RF component using the hardware component of the UE 120a shown in FIG. 1 or FIG. 2 and/or of the apparatus shown in FIG. 9.

In certain aspects, a UE may perform monitoring of concurrent operation of the UE on multiple operating bands within a same SIM or between multiple SIMs that involves sharing at least one RF component with a common entity of the UE. In one example, the common entity coordinates between one or more radio access technologies (RATs) shared within the same SIM. In another example, the common entity coordinates between the one or more RATs shared within the multiple SIMs. The common entity is implemented in software.

In certain aspects, the UE disables the at least one RF component when the common entity determines (based on the monitoring of the concurrent operation) that each of the RATs voted to disable the at least one RF component. For example, when there are 2 RATs and each RAT voted to disable the at least one RF component, the UE will then disable the at least one RF component.

In certain aspects, the UE enables the at least one RF component when the common entity determines (based on the monitoring of the concurrent operation) that at least one of the RATs voted to enable the at least one RF component. For example, when there are 2 RATs and any one RAT voted to enable the at least one RF component, the UE will then enable the at least one RF component.

In certain aspects, a UE may operate with a single SIM in a dual connectivity mode involving a first RAT and a second RAT. The dual connectivity mode corresponds to an evolved universal terrestrial radio access (E-UTRA) new radio (NR)—dual connectivity (ENDC) mode. The first RAT may include a new radio (NR) RAT. The second RAT may include a long term evolution (LTE) RAT.

In certain aspects, a UE may operate with multiple SIMs in a dual-SIM dual active (DSDA) or a dual-SIM dual standby (DSDS) mode.

In certain aspects, at least one RF component of a UE may include a low noise amplifier (LNA), an antenna switch module (ASM), and/or a cross switch.

In certain aspects, a UE may perform monitoring of a concurrent operation on multiple operating bands within a same SIM or between multiple SIMs that involves sharing at least one RF component with a driver control circuit of the UE. The driver control circuit is implemented at a RF device level.

In certain aspects, the UE disables the at least one RF component when the driver control circuit determines (based on the monitoring of the concurrent operation) that each of the RATs voted to disable the at least one RF component.

In certain aspects, the UE enables the at least one RF component when the driver control circuit determines (based on the monitoring of the concurrent operation) that at least one of the RATs voted to enable the at least one RF component.

### Example Wireless Communication Devices

FIG. 9 illustrates a communications device 900 that may include various components (e.g., corresponding to means-plus-function components) configured to perform operations for the techniques disclosed herein, such as the operations illustrated in FIG. 8. The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 is configured to perform processing functions for the communications device 900, including processing signals received and/or to be transmitted by the communications device 900.

The processing system 902 includes a processor 904 coupled to a computer-readable medium/memory 912 via a bus 906. In certain aspects, the computer-readable medium/memory 912 is configured to store instructions (e.g., a computer-executable code) that when executed by the processor 904, cause the processor 904 to perform the operations illustrated in FIG. 8, or other operations for performing the various techniques discussed herein. In certain aspects, computer-readable medium/memory 912 stores code 914 for monitoring and code 916 for enabling or disabling. The code 914 for monitoring may include code for monitoring a concurrent operation on multiple operating bands within a same subscriber identity module (SIM) or between multiple SIMs that involves sharing at least one radio frequency (RF) component. The code 916 for enabling or disabling may include code for enabling or disabling the at least one RF component based on the monitoring.

The processor 904 may include circuitry configured to implement the code stored in the computer-readable medium/memory 912, such as for performing the operations illustrated in FIG. 8, as well as other operations for performing the various techniques discussed herein. For example, the processor 904 includes circuitry 918 for monitoring and circuitry 920 for enabling or disabling. The circuitry 918 for monitoring may include circuitry for monitoring a concurrent operation on multiple operating bands within a same SIM or between multiple SIMs that involves sharing at least one RF component. The circuitry 920 for enabling or disabling may include circuitry for enabling or disabling the at least one RF component based on the monitoring.

### Example Aspects

Implementation examples are described in the following numbered aspects.

In a first aspect, a method for wireless communications by a user equipment (UE), comprising: monitoring a concurrent operation on multiple operating bands within a same subscriber identity module (SIM) or between multiple SIMs that involves sharing at least one radio frequency (RF) component; and enabling or disabling the at least one RF component based on the monitoring.

In a second aspect, alone or in combination with the first aspect, the UE performs the monitoring with a common entity that coordinates between one or more radio access technologies (RATs) shared within the same SIM or the multiple SIMs.

In a third aspect, alone or in combination with one or more of the first and second aspects, the common entity is implemented in software.

In a fourth aspect, alone or in combination with one or more of the first through third aspects, the at least one RF component is disabled when the common entity determines, based on the monitoring, that each of the RATs vote to disable the at least one RF component.

In a fifth aspect, alone or in combination with one or more of the first through fourth aspects, the at least one RF component is enabled when the common entity determines, based on the monitoring, that at least one of the RATs votes to enable the at least one RF component.

In a sixth aspect, alone or in combination with one or more of the first through fifth aspects, the UE operates with a single SIM in a dual connectivity mode involving a first radio access technology (RAT) and a second RAT.

In a seventh aspect, alone or in combination with one or more of the first through sixth aspects, the dual connectivity mode corresponds to an evolved universal terrestrial radio access (E-UTRA) new radio (NR)—dual connectivity (ENDC) mode.

In an eighth aspect, alone or in combination with one or more of the first through seventh aspects, the first RAT comprises a new radio (NR) RAT; and the second RAT comprises a long term evolution (LTE) RAT.

In a ninth aspect, alone or in combination with one or more of the first through eighth aspects, the UE operates with the multiple SIMs in a dual-SIM dual active (DSDA) or a dual-SIM dual standby (DSDS) mode.

In a tenth aspect, alone or in combination with one or more of the first through ninth aspects, the at least one RF component comprises a low noise amplifier (LNA), an antenna switch module (ASM), or a cross switch.

In an eleventh aspect, alone or in combination with one or more of the first through tenth aspects, the UE performs the monitoring with a driver control circuit implemented at a RF device level.

In a twelfth aspect, alone or in combination with one or more of the first through eleventh aspects, the at least one RF component is disabled when the driver control circuit determines, based on the monitoring, that each of multiple radio access technologies (RATs) vote to disable the at least one RF component.

In a thirteenth aspect, alone or in combination with one or more of the first through twelfth aspects, the at least one RF component is enabled when the driver control circuit determines, based on the monitoring, that at least one of multiple radio access technologies (RATs) votes to enable the at least one RF component.

An apparatus for wireless communication, comprising at least one processor; and a memory coupled to the at least one processor, the memory comprising code executable by the at least one processor to cause the apparatus to perform the method of any of the first through thirteenth aspects.

An apparatus comprising means for performing the method of any of the first through thirteenth aspects.

A computer readable medium storing computer executable code thereon for wireless communications that, when executed by at least one processor, cause an apparatus to perform the method of any of the first through thirteenth aspects.

### Additional Considerations

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, allocating, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (UE) 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 8.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a user equipment (UE), comprising:
monitoring a concurrent operation on multiple operating bands within a same subscriber identity module (SIM) or between multiple SIMs that involves sharing at least one radio frequency (RF) component; and
enabling or disabling the at least one RF component based on the monitoring.

2. The method of claim 1, wherein the UE performs the monitoring with a common entity that coordinates between one or more radio access technologies (RATs) shared within the same SIM or the multiple SIMs.

3. The method of claim 2, wherein the common entity is implemented in software.

4. The method of claim 2, wherein the at least one RF component is disabled when the common entity determines, based on the monitoring, that each of the RATs vote to disable the at least one RF component.

5. The method of claim 2, wherein the at least one RF component is enabled when the common entity determines, based on the monitoring, that at least one of the RATs votes to enable the at least one RF component.

6. The method of claim 1, wherein the UE operates with a single SIM in a dual connectivity mode involving a first radio access technology (RAT) and a second RAT.

7. The method of claim 6, wherein the dual connectivity mode corresponds to an evolved universal terrestrial radio access (E-UTRA) new radio (NR)—dual connectivity (ENDC) mode.

8. The method of claim 6, wherein:
the first RAT comprises a new radio (NR) RAT; and
the second RAT comprises a long term evolution (LTE) RAT.

9. The method of claim 1, wherein the UE operates with the multiple SIMs in a dual-SIM dual active (DSDA) or a dual-SIM dual standby (DSDS) mode.

10. The method of claim 1, wherein the at least one RF component comprises a low noise amplifier (LNA), an antenna switch module (ASM), or a cross switch.

11. The method of claim 1, wherein the UE performs the monitoring with a driver control circuit implemented at a RF device level.

12. The method of claim 11, wherein the at least one RF component is disabled when the driver control circuit determines, based on the monitoring, that each of multiple radio access technologies (RATs) vote to disable the at least one RF component.

13. The method of claim 11, wherein the at least one RF component is enabled when the driver control circuit determines, based on the monitoring, that at least one of multiple radio access technologies (RATs) votes to enable the at least one RF component.

14. An apparatus for wireless communications by a user equipment (UE), comprising:
at least one processor and a memory configured to:
monitor a concurrent operation on multiple operating bands within a same subscriber identity module (SIM) or between multiple SIMs that involves sharing at least one radio frequency (RF) component; and
enable or disable the at least one RF component based on the monitoring.

15. The apparatus of claim 14, wherein the UE performs the monitoring with a common entity that coordinates between one or more radio access technologies (RATs) shared within the same SIM or the multiple SIMs.

16. The apparatus of claim 15, wherein the common entity is implemented in software.

17. The apparatus of claim 15, wherein the at least one RF component is disabled when the common entity determines, based on the monitoring, that each of the RATs vote to disable the at least one RF component.

18. The apparatus of claim 15, wherein the at least one RF component is enabled when the common entity determines, based on the monitoring, that at least one of the RATs votes to enable the at least one RF component.

19. The apparatus of claim 14, wherein the UE operates with a single SIM in a dual connectivity mode involving a first radio access technology (RAT) and a second RAT.

20. The apparatus of claim 19, wherein the dual connectivity mode corresponds to an evolved universal terrestrial radio access (E-UTRA) new radio (NR)—dual connectivity (ENDC) mode.

21. The apparatus of claim 19, wherein:
the first RAT comprises a new radio (NR) RAT; and
the second RAT comprises a long term evolution (LTE) RAT.

22. The apparatus of claim 14, wherein the UE operates with the multiple SIMs in a dual-SIM dual active (DSDA) or a dual-SIM dual standby (DSDS) mode.

23. The apparatus of claim 14, wherein the at least one RF component comprises a low noise amplifier (LNA), an antenna switch module (ASM), or a cross switch.

24. The apparatus of claim 14, wherein the UE performs the monitoring with a driver control circuit implemented at a RF device level.

25. The apparatus of claim 24, wherein the at least one RF component is disabled when the driver control circuit determines, based on the monitoring, that each of multiple radio access technologies (RATs) vote to disable the at least one RF component.

26. The apparatus of claim 24, wherein the at least one RF component is enabled when the driver control circuit determines, based on the monitoring, that at least one of multiple radio access technologies (RATs) votes to enable the at least one RF component.
